(19) United States
(12) Patent Application Publication
(10) Pub. No.: US 2008/0155624 A1
(43) Pub. Date: Jun. 26, 2008

(54) Apparatus and Method for Providing Adaptive Broadcast Service Using Classification Schemes for Usage Environment Description

(76) Inventors: Kyoung-Ro Yoon, Seoul (KR); Sun-Young Han, Seoul (KR); Hee-Kyung Lee, Daejeon (KR); Jung-Won Kang, Seoul (KR); Jae-Gon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/813,401

(22) PCT Filed: Jan. 6, 2006
(86) PCT No.: PCT/KR06/00060

§ 371 Date: Sep. 26, 2007

(30) Foreign Application Priority Data
Jan. 7, 2005 (KR) 10-2005-0001869

(51) Int. Cl. H04N 7/173

(52) U.S. Cl. 725/109; 725/105

(57) ABSTRACT

Provided is an apparatus and method for providing an adaptive broadcasting service using classification schemes for Usage Environment Description (UED). The adaptive broadcasting service providing apparatus using UED classification scheme (CS) to provide a targeting function for selecting an Audio video (AV) program, a package or components of the package based on a consumption environment and user preference, in an adaptive broadcasting system for providing broadcasting contents including AV programs and packages to a user terminal, includes: a contents providing means for publishing and providing the broadcasting contents and metadata including the UED CS to the user terminal; and a contents searching means for providing contents identification information corresponding to a search and selection signal inputted from the user terminal, wherein the UED CS is a kind of metadata describing a contents consumption environment in order that the user terminal can select contents which fit to user's environment and preference.

### TECHNICAL FIELD

The present invention relates to an apparatus and method for providing an adaptive broadcasting service using classification schemes for Usage Environment Description (UED); and, more particularly, to an adaptive broadcasting service providing apparatus using UED classification schemes that can provide a targeting function for selecting an Audio/video (AV) program, a package or components of a package based on a user consumption environment and preference in an adaptive broadcasting system such as a TV-Anytime (TVA) system, and a method thereof.

### BACKGROUND ART

As broadcasting is digitalized, broadcasting environments are rapidly changing from conventional unidirectional broadcasting into complexes form such as accommodation of diverse reception terminals based on a linkage between a broadcasting network and a communication network as well as multimedia and multi-channels. Also, viewers who used to inactively receive broadcasting programs in a limited range of channels, want to directly participate in a broadcasting service or receive/watch desired programs at desired time.

It can be summarized that the broadcasting environments evolve into complexly and diversely personalized forms. In the complex, diverse and new broadcasting environments, an adaptive broadcasting makes it possible that the viewers conveniently and efficiently consume desired broadcasting contents in form which fits to the preferences of the viewer at desirable time with diverse terminals. That is, the adaptive broadcasting provides adaptive broadcasting contents, which fit to a usage environment including user preference, terminal performance, network characteristics and a natural environment such as time, place and user's feeling.

The ‘TV-Anytime’ forum is a group for defining a standard for the adaptive broadcasting. The ‘TV-Anytime’ forum is a private standard organization established in September 1999 to develop a standard for providing services related to audio and visual in a user environment having a Personal Digital Recorder (PDR).

The standard for the adaptive broadcasting in the ‘TV-Anytime’ forum is divided into a phase 1, i.e., TVA-1 and a phase 2, i.e., TVA-2 in consideration of an assumed system environment and major functions to be provided.

The TVA-1 is for providing application services such as search, selection, acquisition and consumption of audio/video (AV) contents based on Personal Digital Recorder (PDR) in an environment where a main broadcasting program is transmitted through a unidirectional broadcasting channel and additional metadata can be acquired through a bi-directional network.

The metadata means descriptive data for contents such as a program title, genre and overview, and they are generally defined as data about data.

The TVA-2 extends the consumption environment of the TVA-1 assuming the unidirectional broadcasting channel and the bi-directional network. It provides a package, which can be identified and acquired as one selection unit, by integrating diverse forms of media components such as an application program, a commercial, an image, syntax as well as an AV program, which is an important service object of the TVA-1 in a home network environment.

The package describes information on the package and its components, and provides a targeting function for selecting components from the package based on the consumption environment and user preference and a synchronizing function for proper consumption possible through description on temporal/spatial relationships.

Also, the TVA system provides a targeting function for selecting the provided AV program, package, components of the package according to fit the consumption environment and the user preference.

Herein, it is required to clearly define and use classification schemes for describing usage environment such as the type of a user terminal or the location of a user in detail to efficiently support the targeting function.

### DISCLOSURE

### Technical Problem

It is, therefore, an object of the present invention to provide an adaptive broadcasting service providing apparatus that can efficiently support a targeting function for selecting an Audio/video (AV) program, a package or components of the package based on a user consumption environment and preference by defining and using Usage Environment Description (UED) classification schemes for clearly classifying and describing usage environment in detail.

Other objects and advantages of the invention will be understood by the following description and become more apparent from the embodiments in accordance with the present invention, which is set forth hereinafter. It will be also apparent that objects and aspects of the invention can be embodied easily by the means defined in the claims and combinations thereof.

### Technical Solution

In accordance with one aspect of the present invention, there is provided an adaptive broadcasting service providing apparatus using Usage Environment Description (UED) classification schemes (CS) to provide a targeting function for selecting an Audio video (AV) program, a package or components of the package based on a consumption environment and user preference, in an adaptive broadcasting system for providing broadcasting contents including AV programs and packages to a user terminal, including: a contents providing unit for publishing and providing the broadcasting contents and metadata including the UED classification schemes to the user terminal; and a contents searching unit for providing contents identification information corresponding to a search and selection signal inputted from the user terminal, wherein the UED classification schemes are metadata describing a contents consumption environment so that the user terminal can select contents which fit to user's environment and preference.

In accordance with another aspect of the present invention, there is provided an adaptive broadcasting service providing method using Usage Environment Description (UED) classification schemes (CS) to provide a targeting function for selecting an Audio video (AV) program, a package or components of the package based on a consumption environment and user preference, in an adaptive broadcasting system for providing broadcasting contents including AV programs and packages to a user terminal, including the steps of: a) publishing metadata including the broadcasting contents and the UED classification schemes to the user terminal; b) providing contents identification information corresponding to a search and selection signal transmitted from the user terminal; c) determining physical location of the broadcasting contents based on the contents identification information and providing location information; and d) providing the broadcasting contents based on the location information, wherein the UED classification schemes are metadata describing a consumption environment of the contents so that the user terminal can select contents which fit to user's environment and preference.

In accordance with another aspect of the present invention, there is provided an adaptive broadcasting system using UED classification schemes (CS), including: an adaptive broadcasting service providing apparatus for providing broadcasting contents including an audio/video (AV) program and a package, and providing an adaptive broadcasting service supporting a synchronizing function; and a targeting function and a user terminal for receiving and consuming the broadcasting contents and the metadata from the adaptive broadcasting service providing apparatus, wherein the UED classification schemes are metadata describing a consumption environment of the contents so that the user terminal can select contents which fit to user's environment and preference.

In accordance with another aspect of the present invention, there is provided an user terminal for receiving broadcasting contents including an audio/video (AV) program and a package by using Usage Environment Description (UED) in an adaptive broadcasting system for providing an adaptive broadcasting service supporting a synchronizing function and a targeting function from an adaptive broadcasting service providing apparatus to the user terminal, the user terminal including: a user interacting unit for searching, selecting and acquiring broadcasting contents based on metadata including the UED classification schemes (CS) published from the adaptive broadcasting service providing apparatus; a local storage managing unit for storing and managing the acquired broadcasting contents and metadata; and a contents presenting unit for presenting the broadcasting contents and the metadata such that a user can use the broadcasting contents and the metadata, wherein the UED classification schemes are metadata describing a consumption environment of the contents such that the user terminal can select contents which fit to user's environment and preference.

In accordance with another aspect of the present invention, there is provided an metadata structure, including: UED classification schemes for a TV-Anytime (TVA) broadcasting service, wherein the UED classification schemes (CS) include, a terminal type classification scheme for describing types of user terminals; a location type classification scheme for describing environment conditions of user location; and a weather type classification scheme for defining and describing weather environment conditions.

### Advantageous Effects

The technology of the present invention can provide diverse classification schemes for Usage Environment Description (UED) in an adaptive broadcasting system such as a TV-Anytime (TVA) system to thereby provide audio video (AV) program, a package or components of the package provided by the adaptive broadcasting system adaptively suitable for a newly defined consumption environment and user preference and to provide an advanced targeting function can be provided.

### DESCRIPTION OF DRAWINGS

The above and other objects and features of the present invention will become apparent from the following description of the preferred embodiments given in conjunction with the accompanying drawings, in which:

FIG. 1 is a block diagram showing an entire adaptive broadcasting system in accordance with an embodiment of the present invention;

FIG. 2 is a block diagram illustrating the adaptive broadcasting system in detail in accordance with the embodiment of the present invention; and

FIG. 3 is a flowchart describing an adaptive broadcasting service providing process using Usage Environment Description (UED) classification schemes in accordance with an embodiment of the present invention.

### BEST MODE FOR THE INVENTION

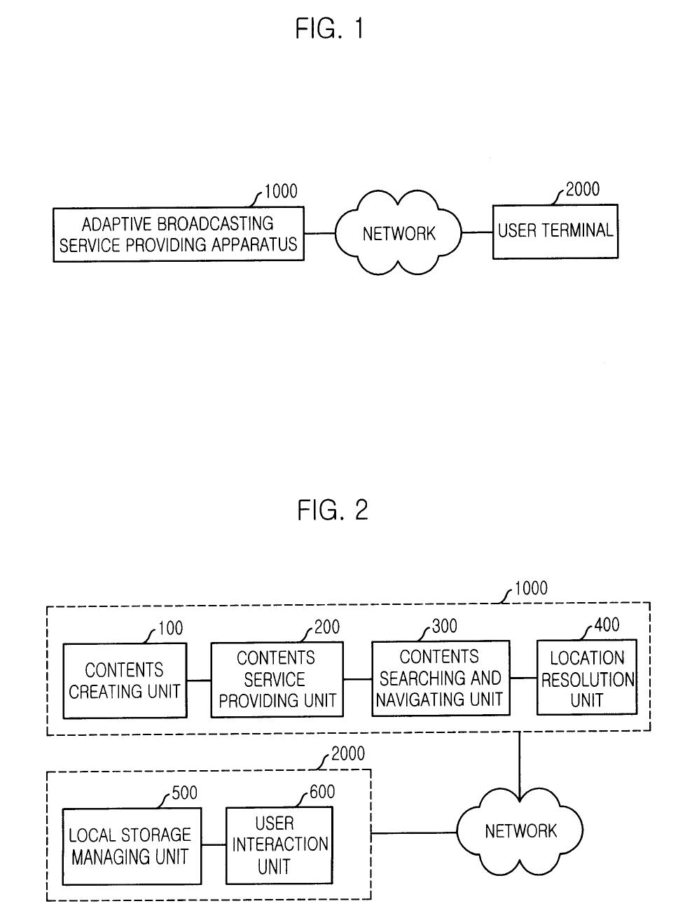

FIG. 1 is a block diagram showing an entire structure of an adaptive broadcasting system in accordance with an embodiment of the present invention.

As shown in FIG. 1, the adaptive broadcasting system of the present invention includes an adaptive broadcasting service providing apparatus 1000 for providing broadcasting contents including an audio/video (AV) program and a package, and an adaptive broadcasting service supporting a synchronizing function and a targeting function, and a user terminal 2000 for consuming an application service such as contents search, selection, acquisition, and consumption by using contents and contents-related metadata from the adaptive broadcasting service providing apparatus 1000, which are connected to a network including a broadcasting channel/bi-directional IP network.

FIG. 2 is a block diagram illustrating the adaptive broadcasting system in detail in accordance with the embodiment of the present invention.

As shown in FIG. 2, the adaptive broadcasting service providing apparatus 1000 includes a contents creating unit 100, a contents service providing unit 200, a contents searching and navigating unit 300 and a location resolution unit 400, and the user terminal 2000 includes a user interaction unit 600 and a local storage managing unit 500, and further includes a contents presenting unit (not shown) and a rights managing and protecting unit (not shown), which are not shown in the drawing. Functions of each constituent element are as follows.

The contents creating unit 100 creates an audio/video (AV) program and a package. A studio, an entertainment company, a Web designer, or a user adaptive contents producer can manage the work.

The contents service providing unit 200 reorganizes contents and metadata, inserts metadata and transmits contents, and a terrestrial, satellite and cable broadcasting companies, Web casters or portal providers can manage the work.

The contents searching and navigating unit 300 is based on broadcasting metadata published in Electronic Program Guide (EPG) for available contents. A contents searching and navigating function returns a contents identifier (CRID) of contents selected by a user or automatically selected by a terminal.

The location resolution unit 400 determines a physical location of contents including a channel and broadcasting time from the CRID acquired from the contents searching and navigating unit 300.

The local storage managing unit 500 stores and manages broadcasting contents and metadata. The metadata can be managed in an Extensible Markup Language (XML) database (DB) or a relational DB. A function connecting the bi-directional metadata between a user and a service provider is based on user history information and user preference information from the user.

The user interaction unit 600 drives constituent elements based on a user input signal inputted from an input device of a user terminal, e.g., a key board, a remote controller, a mouse and a joystick.

The contents presenting unit (not shown) provides broadcasting contents and metadata to the user terminal such that a user can use.

The rights managing and protecting unit (not shown) protects interface between the constituent elements based on a proper protecting/managing policy (refer to ETSI TS 102 822-5-1/2 and ETSI TS 102 822-7 “Bimetadata delivery protection”).

The above-mentioned embodiment is an example of the adaptive broadcasting system in a complete bi-directional broadcasting environment.

A method for realizing the adaptive broadcasting system is largely divided into two based on a service environment. In a broadcasting environment having a sheer unidirectional broadcasting environment or a narrow-band bi-directional channel, only the contents creating unit and the contents service providing unit among the elements of the adaptive broadcasting system exist in the outside of the user terminal, e.g., Personal Digital Recorder (PDR), and all elements except the contents creating unit and the contents service providing unit makes a user be able to consume desired contents through search, selection, location resolution and acquisition processes in the PDR.

Meanwhile, as described in the above embodiment, in a complete bi-directional broadcasting environment, the contents searching/navigating unit and the location resolution unit as well as the contents creating unit and the contents service providing unit among components of the adaptive broadcasting system can exist in the outside of the PDR. Therefore, the PDR makes a user be able to consume desired contents through search, selection, location resolution and acquisition processes through bi-directional connection to the contents service providing unit or the contents searching and navigating unit by including only the user interaction unit, the contents presenting unit and the local storage managing unit.

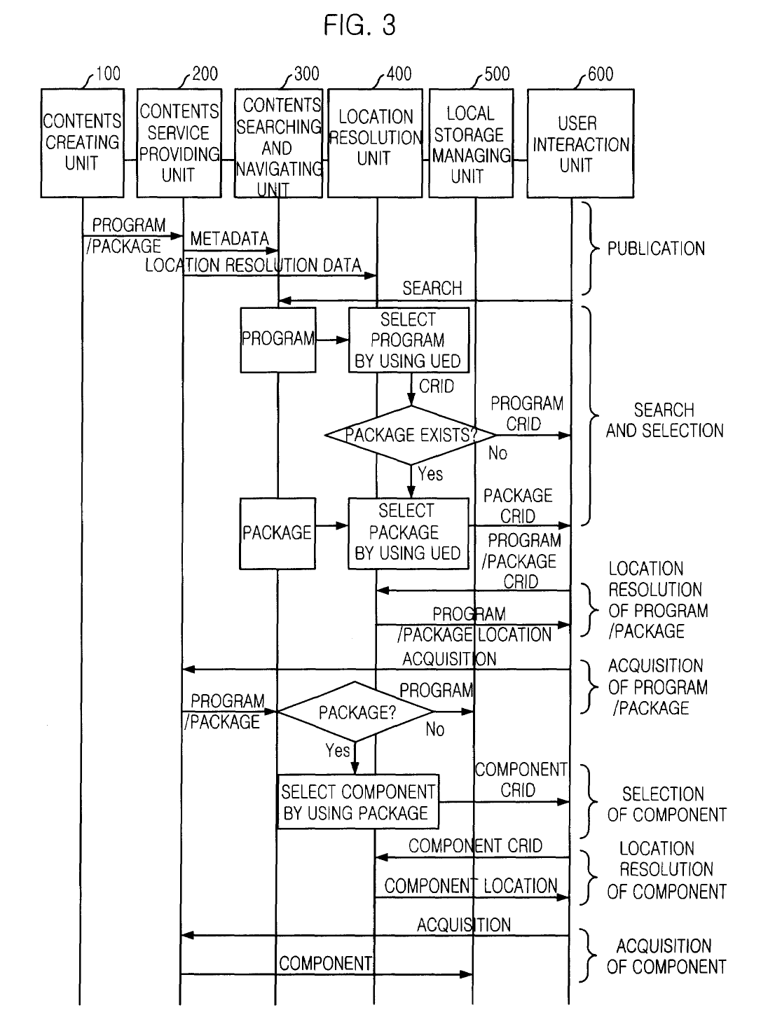

FIG. 3 is a flowchart describing an adaptive broadcasting service providing process using UED classification schemes in accordance with an embodiment of the present invention.

The adaptive broadcasting service providing process of the present invention basically includes the steps of publication, search, selection, location resolution, acquisition, view and finish.

There are three operation scenarios, which are largely divided based on whether serviced contents are an AV program or package, and whether the serviced package is independent or dependent on the AV program.

Publication

When an AV program is provided, the contents creating unit 100 creates the AV program. The contents service providing unit 200 publishes Content Reference Identifier (CRID) for identifying the AV program, attractive metadata of the AV program, schedule information and location resolution data.

Herein, the attractive metadata and schedule information of the AV program are described as program information and program location of a TVA-1 metadata schema.

The contents service providing unit 200 has a user be able to select an AV program that fits to an environment and preference of the user by publishing user environment and preference, in which the AV program is properly consumed, based on the UED classification schemes in “TargetingInformation” i.e., a lower component of the program information. That is, the UED classification schemes of the present invention are provided to the user in the form of the metadata.

When a package to be provided is independent from the AV program, the contents creating unit 100 creates only the package. The package is described based on a TVA-2 package schema and has a user be able to select a component which fits to an environment and preference of the user by publishing the proper user environment, in which each component included in the package can be properly consumed, and preference based on the UED classification scheme in “TargetingInformation”, which is a lower component of ContentsDescription component.

The contents service providing unit 200 publishes the CRID for identifying the package, the package attractive metadata for inducing package consumption and approximate schedule information of the package. Also, location resolution data for describing when and where the package can be acquired is published. As described above, the attractive metadata and the schedule information of the package are described as the program information (ProgramInformation) and program location (ProgramLocation) of the TVA-1 metadata schema, just as a general AV program. The contents service providing unit 200 has a user be able to select a package which fits to an environment and preference of the user, by publishing proper user environment, in which the package is properly consumed, and preference by applying the UED classification schemes of the present invention in “TargetingInformation” i.e., a lower component of the program information.

Meanwhile, when the package to be provided is dependent on the AV program, the contents creating unit 100 creates an AV program and a package dependent on the AV program. The contents service providing unit 200 publishes the CRID for identifying the AV program, attractive metadata of the AV program, schedule information, location resolution information, link information of the package connected to the AV program. Herein, the attractive metadata and the schedule information of the AV program are described as the program information and the program location of the TVA-1 metadata schema, and link information of the package connected to the AV program is described as a “RelatedMaterial” component of the program information of the AV program. The contents service providing unit 200 has a user be able to select an AV program, which fits to an environment and preference of the user, by publishing user environment in which the AV program is properly consumed and preference by applying the UED classification schemes of the present invention in “TargetingInformation”, i.e., a lower component of the program information. The homogeneous or heterogeneous contents service providing unit 200 publishes location resolution data for describing when and where the CRID for identifying the package and the package can be acquired.

Search

When the AV program is provided, the contents searching and navigating unit 300 provides the attractive metadata and the schedule information of the AV program to the user through the EPG. Also, the EPG provides proper user environment and preference information, in which the AV program can be properly consumed, which were described in “TargetingInformation”, based on the UED CS of the present invention.

The user grasps the attractive metadata of the AV program such as the title, synopsis and actors of the AV program provided by the EPG, and searches the AV program to be consumed in the contents searching and navigating unit 300 by comparing the proper user environment and preference with the user's own environment and preference.

When the provided package is independent from the AV program, the EPG provides the package attractive metadata and the package schedule information to the user. Also, the EPG provides the proper user environment, in which the package is properly consumed, and preference information, which were described in “TargetingInformation”, based on the UED classification schemes of the present invention.

The user grasps the package attractive metadata such as the package title, synopsis and actors of the AV program provided by the EPG, and searches the package to be consumed by comparing the proper user environment and preference with the user's own environment and preference.

When the provided package is dependent on the AV program, the EPG provides link information of the package connected to the AV program along with the attractive metadata and the schedule information of the AV program. Also, the EPG provides the proper user environment, in which the AV program is properly consumed, and preference information, which were described in “TargetingInformation”, based on the UED classification schemes of the present invention.

The user grasps the attractive metadata of the AV program such as the title, synopsis and actors of the AV program provided by the EPG, and searches the AV program to be consumed by comparing the proper user environment, in which the AV program can be properly consumed, and preference with the user's own environment and preference.

When the user searches the AV program or uses the program through the EPG, the user acquires information on the package connected to the AV program.

Selection

In case of an AV program, when the user selects an AV program preferred by the user in the EPG, the user acquires the CRID of the AV program from the contents searching and navigating unit 300.

When the provided package is independent from the AV program, the user acquires the CRID of the package when he selects the package preferred by the user in the EPG.

When the provided package is dependent on the AV program and the user selects the AV program out of preference in the EPG, the user acquires the CRID of the package connected to the AV program from a “RelatedMaterial” component of the program information of the AV program.

Location Resolution

Both of the AV program and the package acquire physical location information of a real AV program and the package provided by the location resolution unit 400 through a location resolution mechanism from the CRID. The local storage managing unit 500 selects any one location among a plurality of contents locations including both channel and time informations to prevent collision during recording.

Acquisition

An AV program or a package is acquired based on the selected location information including both channel and time informations.

When a package is acquired, the user grasps attractive metadata of each component included in the package, and automatically or semiautomatically selects the entire or part of components to be consumed by comparing a proper user environment, in which the components can be properly consumed, and preference information which were described in “TargetingInformation,” i.e., a low-order element of the “ContentDescription,” based on the UED classification schemes of the present invention with the user's own environment and preference.

When components are selected, physical location information providing an actual component from the location resolution unit 400 is acquired from the CRID of each component through a location resolution mechanism.

View

When an AV program is acquired, the AV program is outputted into a user screen such that the user can use the AV program. When a package is acquired, the package is provided to the user after all components selected by the user are acquired and screens are formed by using spatial/temporal relation information between components such that the user can use the package or the AV program.

Finishing

The AV program and package usage history information of the user is stored in a terminal and used to extract user preference.

Many embodiments of the UED classification schemes suggested in the present invention will be described in detail hereinafter.

The UED classification schemes of the present invention define terms for the UED classification schemes required for providing the adaptive broadcasting service of the present invention in addition to terms defined in the UED classification scheme defined in MPEG-21 Part 7 DIA.

Among the terms used in the UED classification schemes of the present invention, since the same components as the terms defined in the UED classification scheme defined in the MPEG-21 Part 7 DIA have the same definition as the term, detailed description will not be provided herein.

The UED classification schemes of the present invention include terminal type classification scheme information (TerminalTypeCS), place type classification scheme information (PlaceTypeCS) and weather type classification scheme information (WeatherTypeCS).

The terminal type classification schemes defines terms for “TerminalType” of “TerminalInformationType”, and it further includes car terminal type information for describing diverse types of the car terminals among user terminals by adding the terms defined in the MPEG-21 Part 7.

The car terminal information includes such terms as car stereo, car navigation and car AV, to thereby specifically classify the kinds of the car terminals of the user.

An XML syntax of the TerminalTypeCS is as follows.

```
<ClassificationScheme
uri=“urn:tva:2005:01-UED-TerminalTypeCS-NS” >
    <Term termId=“1”>
        <Name xml:lang=“en”>PC</Name>
    </Term>
    <Term termId=“2”>
        <Name xml:lang=“en”>PDA</Name>
    </Term>
    <Term termId=“3”>
        <Name xml:lang=“en”>Set-Top Box</Name>
    </Term>
    <Term termId=“4”>
        <Name xml:lang=“en”>Printer</Name>
    </Term>
    <Term termId=“5”>
        <Name xml:lang=“en”>Mobile Phone</Name>
    </Term>
    <Term termId=“6”>
        <Name xml:lang=“en”>Digital Still Camera</Name>
    </Term>
    <Term termId=“7”>
        <Name xml:lang=“en”>Digital Video Camera</Name>
    </Term>
    <Term termId=“8”>
        <Name xml:lang=“en”>Audio Player</Name>
    </Term>
    <Term termId=“9”>
        <Name xml:lang=“en”>Television</Name>
    </Term>
    <Term termId=“10”>
        <Name xml:lang=“en”>Gateway</Name>
    </Term>
    <Term termId=“11”>
        <Name xml:lang=“en”>Router</Name>
    </Term>
    <Term termId=“12”>
        <Name xml:lang=“en”>Car Terminal</Name>
    </Term>
        <Term termId=“12.1”>
        <Name xml:lang=“en”>Car Stereo</Name>
    </Term>
        <Term termId=“12.2”>
        <Name xml:lang=“en”>Car Navigation</Name>
    </Term>
        <Term termId=“12.3”>
        <Name xml:lang=“en”>Car AV</Name>
    </Term>
</ClassificationScheme>
```

The PlaceTypeCS is used for “Location” of “NaturalEnvironmentInformationTableType”, and includes mobility type information which describes diverse motion environment conditions of a user in motion in addition to the term defined in the MPEG-21 part 7.

The mobility type information includes a transportation traffic type showing a motion type that a user uses a public transportation, a car type showing a motion type that a user uses a car for transportation, a train type showing a motion type that a user uses a train, an airplane type showing a motion type that a user uses an airplane and an ‘on foot’ type showing a motion type that a user moves on foot, and the ‘on foot’ type includes walking and running types.

The XML syntax of the PlaceTypeCS is as follows.

```
<ClassificationScheme uri=“urn:tva:2005:01-UED-PlaceTypeCS-NS”>
    <Term termId=“1”>
        <Name xml:lang=“en”>My Home</Name>
        <Definition xml:lang=”en”>
            A place where a person lives or a place to go back
        </Definition>
    </Term>
    <Term termId=“2”>
        <Name xml:lang=“en”>Transportation Facilities</Name>
        <Definition xml:lang=”en”>
            A place where people access transportation means
        </Definition>
        <Term termId=“2.1”>
            <Name xml:lang=“en”>Station</Name>
        </Term>
        <Term termId=“2.2”>
            <Name xml:lang=“en”>Stop</Name>
        </Term>
        <Term termId=“2.3”>
            <Name xml:lang=“en”>Airport</Name>
        </Term>
        <Term termId=“2.4”>
            <Name xml:lang=“en”>Harbor</Name>
        </Term>
    </Term>
    <Term termId=“3”>
        <Name xml:lang=“en”>Traffic Facilities</Name>
        <Definition xml:lang=”en”>
            A place where people access by using traffic means
        </Definition>
        <Term termId=“3.1”>
            <Name xml:lang=“en”>Entrance</Name>
        </Term>
        <Term termId=“3.2”>
            <Name xml:lang=“en”>Parking</Name>
        </Term>
        <Term termId=“3.3”>
            <Name xml:lang=“en”>Crossing</Name>
        </Term>
        <Term termId=“3.4”>
            <Name xml:lang=“en”>Street</Name>
        </Term>
        <Term termId=“3.5”>
            <Name xml:lang=“en”>Gas Station</Name>
        </Term>
        <Term termId=“3.6”>
            <Name xml:lang=“en”>Highway</Name>
        </Term>
        <Term termId=“3.7”>
            <Name xml:lang=“en”>Interchange</Name>
        </Term>
        <Term termId=“3.8”>
            <Name xml:lang=“en”>Service Area</Name>
        </Term>
    </Term>
    <Term termId=“4”>
        <Name xml:lang=“en”>Work Place</Name>
        <Definition xml:lang=”en”>
            A place where people work
        </Definition>
        <Term termId=“4.1”>
            <Name xml:lang=“en”>Office</Name>
        </Term>
        <Term termId=“4.2”>
            <Name xml:lang=“en”>Factory</Name>
        </Term>
        <Term termId=“4.3”>
            <Name xml:lang=“en”>Studio</Name>
        </Term>
        <Term termId=“4.4”>
            <Name xml:lang=“en”>Outdoor</Name>
        </Term>
    </Term>
    <Term termId=“5”>
        <Name xml:lang=“en”>School</Name>
        <Definition xml:lang=”en”>
            A place where a person goes to study
        </Definition>
        <Term termId=“5.1”>
            <Name xml:lang=“en”>University</Name>
        </Term>
        <Term termId=“5.2”>
            <Name xml:lang=“en”>High School</Name>
        </Term>
        <Term termId=“5.3”>
            <Name xml:lang=“en”>Kindergarten</Name>
        </Term>
    </Term>
    <Term termId=“6”>
        <Name xml:lang=“en”>Hall</Name>
        <Definition xml:lang=“en”>
            A place or building used for meeting,
entertainment, exhibition, etc.
        </Definition>
        <Term termId=“6.1”>
            <Name xml:lang=“en”>Museum</Name>
        </Term>
        <Term termId=“6.2”>
            <Name xml:lang=“en”>Library</Name>
        </Term>
        <Term termId=“6.3”>
            <Name xml:lang=“en”>Theater</Name>
        </Term>
    </Term>
    <Term termId=“7”>
        <Name xml:lang=“en”>Public Facilities</Name>
        <Definition xml:lang=”en”>
            A place or building for public service
        </Definition>
        <Term termId=“7.1”>
            <Name xml:lang=“en”>Bank</Name>
        </Term>
        <Term termId=“7.2”>
            <Name xml:lang=“en”>Post Office</Name>
        </Term>
        <Term termId=“7.3”>
            <Name xml:lang=“en”>Hospital</Name>
        </Term>
        <Term termId=“7.4”>
            <Name xml:lang=“en”>Police</Name>
        </Term>
        <Term termId=“7.5”>
            <Name xml:lang=“en”>Public Office</Name>
        </Term>
        <Term termId=“7.6”>
            <Name xml:lang=“en”>Fire-Brigade Station</Name>
        </Term>
    </Term>
    <Term termId=“8”>
        <Name xml:lang=“en”>Historic Site</Name>
        <Definition xml:lang=”en”>
            A place or building of historic interest and value
        </Definition>
        <Term termId=“8.1”>
            <Name xml:lang=“en”>Palace</Name>
        </Term>
        <Term termId=“8.2”>
            <Name xml:lang=“en”>Castle</Name>
        </Term>
        <Term termId=“8.3”>
            <Name xml:lang=“en”>Church</Name>
        </Term>
        <Term termId=“8.4”>
            <Name xml:lang=“en”>Temple</Name>
        </Term>
        <Term termId=“8.5”>
            <Name xml:lang=“en”>Shrine</Name>
        </Term>
        <Term termId=“8.6”>
            <Name xml:lang=“en”>Graveyard</Name>
        </Term>
    </Term>
    <Term termId=“9”>
        <Name xml:lang=“en”>Natural Outdoor Spot</Name>
        <Definition xml:lang=“en”>
            A spot of natural or outdoor environment
        </Definition>
        <Term termId=“9.1”>
            <Name xml:lang=“en”>Mountain</Name>
        </Term>
        <Term termId=“9.2”>
            <Name xml:lang=“en”>Sea</Name>
        </Term>
        <Term termId=“9.3”>
            <Name xml:lang=“en”>Lake</Name>
        </Term>
        <Term termId=“9.4”>
            <Name xml:lang=“en”>Pond</Name>
        </Term>
        <Term termId=“9.5”>
            <Name xml:lang=“en”>River</Name>
        </Term>
        <Term termId=“9.6”>
            <Name xml:lang=“en”>Valley</Name>
        </Term>
        <Term termId=“9.7”>
            <Name xml:lang=“en”>Field</Name>
        </Term>
        <Term termId=“9.8”>
            <Name xml:lang=“en”>Island<Name>
        </Term>
        <Term termId=“9.9”>
            <Name xml:lang=“en”>Sky</Name>
        </Term>
    </Term>
    <Term termId=“10”>
        <Name xml:lang=“en”>Hotel</Name>
        <Definition xml:lang=”en”>
            A building or place where people stay, sleep or
take a rest
        </Definition>
    </Term>
    <Term termId=“11”>
        <Name xml:lang=“en”>Restaurant</Name>
        <Definition xml:lang=”en”>
            A building or place where foods are served and
people can eat
        </Definition>
    </Term>
    <Term termId=“12”>
        <Name xml:lang=“en”>Shopping Spot</Name>
        <Definition xml:lang=”en”>
            A building or place where people go shopping
        </Definition>
            <Term termId=“12.1”>
                <Name xml:lang=“en”>Department Store</Name>
            </Term>
            <Term termId=“12.2”>
                <Name xml:lang=“en”>Supermarket</Name>
            </Term>
            <Term termId=“12.3”>
                <Name xml:lang=“en”>Shop</Name>
            </Term>
    </Term>
    <Term termId=“13”>
        <Name xml:lang=“en”>Leisure Spot</Name>
        <Definition xml:lang=”en”>
            A place where people enjoy leisure
        </Definition>
        <Term termId=“13.1”>
            <Name xml:lang=“en”>Park</Name>
        </Term>
        <Term termId=“13.2”>
            <Name xml:lang=“en”>Garden</Name>
        </Term>
        <Term termId=“13.3”>
            <Name xml:lang=“en”>Amusement Park</Name>
        </Term>
        <Term termId=“13.4”>
            <Name xml:lang=“en”>Resort</Name>
        </Term>
        <Term termId=“13.5”>
            <Name xml:lang=“en”>Hot Spring</Name>
        </Term>
    </Term>
    <Term termId=“14”>
        <Name xml:lang=“en”>Sports Spot</Name>
        <Definition xml:lang=”en”>
            A place where people enjoy sports
        </Definition>
        <Term termId=“14.1“>
            <Name xml:lang=“en”>Stadium</Name>
        </Term>
        <Term termId=“14.2”>
            <Name xml:lang=“en”>Sports Gym</Name>
        </Term>
        <Term termId=“14.3”>
            <Name xml:lang=“en”>Tennis Court</Name>
        </Term>
        <Term termId=“14.4”>
            <Name xml:lang=“en”>Golf Course</Name>
        </Term>
        <Term termId=“14.5”>
            <Name xml:lang=“en”>Swimming Pool</Name>
        </Term>
        <Term termId=“14.6”>
            <Name xml:lang=“en”>Skiing Ground</Name>
        </Term>
        <Term termId=“14.7”>
            <Name xml:lang=“en”>Skating Rink</Name>
        </Term>
    </Term>
    <Term termId=“15”>
        <Name xml:lang=“en”>Mobility</Name>
        <Definition xml:lang=”en”>
            The user is in move.
        </Definition>
            <Term termId=“15.1”>
                <Name xml:lang=“en”>In Transportation</Name>
            <Term termId=“15.1.1”>
                <Name xml:lang=“en”>In Car</Name>
            </Term>
            <Term termId=“15.1.2”>
                <Name xml:lang=“en”>In Train</Name>
            </Term>
            <Term termId=“15.1.3”>
                <Name xml:lang=“en”>In Airplane</Name>
            </Term>
            </Term>
            <Term termId=“15.2”>
                <Name xml:lang=“en”>On Foot</Name>
            <Term termId=“15.2.1”>
                <Name xml:lang=“en”>Walking</Name>
            </Term>
            <Term termId=“15.2.2”>
                <Name xml:lang=“en”>Running</Name>
            </Term>
            </Term>
    </Term>
</ClassificationScheme>
```

The WeatherTypeCS defines terms for the “WeatherType” of “NaturalEnvironmentInformationTableType”, and as a classification scheme not defined in MPEG-7 or MPEG-21, standard meteorological terms for classifiably describing diverse weather conditions are defined as the following XML syntax.

To be specific, the WeatherTypeCS defines and describes four season terms such as spring, summer, autumn and winter, general weather classification terms such as sunny, rainy, cloudy, snowy, windy, foggy, frosty and storm and extreme weather classification terms.

Herein, the term ‘Storm’ among the weather classification terms is divided into ‘thunderstorm’ meaning a storm with a thunder, ‘rainstorm’ meaning a storm with rain and ‘snowstorm’ meaning a storm with snow.

Also, the term ‘extreme weather’ is divided into hurricane, typhoon and tornado.

The XML syntax of the WeatherTypeCS is as follows.

<xml version=“1.0” encoding=“UTF-8”>
<ClassificationScheme
uri=“urn:tva:metadata:extended:cs:WeatherTypeCS:2005”>

<Term termId=“1”>

<Name xml : lang=“en”>Spring</Name>
<Definition xml : lang=“en”>

The season between winter and summer in which

leaves and flowers appear.

</Definition>

</Term>
<Term termId=“2”>

<Name xml : lang=“en”>Summer</Name>
<Definition xml : lang=“en”>

The season between spring and autumn when the sun

is hot and there are many flower.

</Definition>

</Term>
<Term termId=“3”>

<Name xml : lang=“en”>Autumn</Name>
<Definition xml : lang=“en”>

The season between summer and winter when leaves

turn gold and fruits become ripe.

</Definition>

</Term>
<Term termId=“4”>

<Name xml : lang=“en”>Winter</Name>
<Definition xml : lang=“en”>

The season between autumn and spring when it is

cold and most trees have lost their leaves.

</Definition>

</Term>
<Term termId=“5”>

<Name xml : lang=“en”>Sunny</Name>
<Definition xml : lang=“en”>

Having bright sunlight.

</Definition>

</Term>
<Term termId=“6”>

<Name xml : lang=“en”>Rainy</Name>
<Definition xml : lang=“en”>

Having a lot of rain.

</Definition>

</Term>
<Term termId=“7”>

<Name xml : lang=“en”>Cloudy</Name>
<Definition xml : lang“en”>

Full of clouds.

</Definition>

</Term>
<Term termId=“8”>

<Name xml : lang=“en”>Snowy</Name>
<Definition xml : lang=“en”>

Full of snow or snowing.

</Definition>

</Term>
<Term termId“9”>

<Name xml : lang=“en”>Windy</Name>
<Definition xml : lang=“en”>

With a lot of wind.

</Definition>

</Term>
<Term termId=“10”>

<Name xml : lang=“en”>Foggy</Name>
<Definition xml : lang=“en”>

With a lot of fog.

</Definition>

</Term>
<Term termId=“11”>

<Name xml : lang=“en”>Frosty</Name>
<Definition xml : lang“en”>

With a lot of frost.

</Definition>

</Term>
<Term termId=“12”>

<Name xml : lang=“en”>Storm</Name>
<Definition xml : lang=“en”>

A rough weather condition with wind, rain, and

often lightning.

</Definition>
<Term termId=“12.1”>

<Name xml : lang=“en”>ThunderStorm</Name>

</Term>
<Term termId=“12.2”>

<Name xml : lang=“en”>RainStorm</Name>

</Term>
<Term termId=“12.3”>

<Name xml : lang=“en”>SnowStorm</Name>

</Term>

</Term>
<Term termId=“13”>

<Name xml : lang=“en”>Extreme Weather</Name>
<Term termId=“13.1”>

<Name xml : lang=“en”>Hurricane</Name>

</Term>
<Term termId=“13.2”>

<Name xml : lang=“en”>Typhoon</Name>

</Term>
<Term termId=“13.3”>

<Name xml : lang=“en”>Tornado</Name>

</Term>

</Term>

</ClassificationScheme>

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention is used for TV-Anytime (TVA) systems.

What is claimed is:

1. An adaptive broadcasting service providing apparatus using Usage Environment Description (UED) classification schemes (CS) to provide a targeting function for selecting an Audio video (AV) program, a package or components of the package based on a consumption environment and user preference, in an adaptive broadcasting system for providing broadcasting contents including AV programs and packages to a user terminal, comprising:
a contents providing means for publishing and providing the broadcasting contents and metadata including the UED classification schemes to the user terminal; and
a contents searching means for providing contents identification information corresponding to a search and selection signal inputted from the user terminal,
wherein the UED CS is a kind of metadata describing a contents consumption environment.

2. The apparatus as recited in claim 1, wherein the contents providing means, includes:
a contents creating unit for creating an AV program and/or package that forms the broadcasting contents; and
a contents service providing unit for providing metadata including the UED CS.

3. The apparatus as recited in claim 2, wherein when a package independent from the AV program is provided, the contents creating means creates only the package, and when a package dependent on the AV program is provided, the contents creating means creates the AV program and the package.

4. The apparatus as recited in claim 1, wherein the contents searching means provides metadata including the UED CS by using Electronic Program Guide (EPG).

5. The apparatus as recited in claim 1, wherein the UED CS includes a terminal type CS for classifiably describing a type of the user terminal.

6. The apparatus as recited in claim 5, wherein the terminal type CS includes car terminal type CS information for describing types of the car terminal.

7. The apparatus as recited in claim 6, wherein the car terminal type CS describes a car stereo, car navigation and a car AV.

8. The apparatus as recited in claim 5, wherein the terminal type CS includes car terminal type CS information described as the following Extensible Markup Language (XML) syntax.
```
<Term termId=“12”>
    <Name xml:lang=“en”>Car Terminal</Name>
</Term>
    <Term termId=“12.1”>
    <Name xml:lang=“en”>Car Stereo</Name>
</Term>
    <Term termId=“12.2”>
    <Name xml:lang=“en”>Car Navigation</Name>
</Term>
    <Term termId=“12.3”>
    <Name xml:lang=“en”>Car AV</Name>
</Term>
```

9. The apparatus as recited in claim 1, wherein the UED CS includes a location type CS for describing an environment condition of a user.

10. The apparatus as recited in claim 9, wherein the location type CS includes motion type information for classifiably describing a motion environment condition of a user in mobile.

11. The apparatus as recited in claim 10, wherein the motion type information includes:
public transportation type information indicating that a user uses a public transportation;
car type information indicating that a user uses a car;
train type information indicating that a user uses a train;
airplane type information indicating that a user uses an airplane; and
walking type information indicating that a user moves on foot.

12. The apparatus as recited in claim 11, wherein the walking type information describes types of walking and types of running.

13. The apparatus as recited in claim 10, wherein the location type CS include motion type classification information expressed as XML syntax as follows:
```
<Term termId=“15”>
    <Name xml:lang=“en”>Mobility</Name>
    <Definition xml:lang=~en~>
        The user is in move.
    </Definition>
        <Term termId=“15.1”>
            <Name xml:lang=“en”>In Transportation</Name>
        <Term termId=“15.1.1”>
            <Name xml:lang=“en”>In Car</Name>
        </Term>
        <Term termId=“15.1.2”>
            <Name xml:lang=“en”>In Train</Name>
        </Term>
        <Term termId=“15.1.3”>
            <Name xml:lang=“en”>In Airplane</Name>
        </Term>
        </Term>
        <Term termId=“15.2”>
            <Name xml:lang=“en”>On Foot</Name>
        <Term termId=“15.2.1”>
            <Name xml:lang=“en”>Walking<Name>
        </Term>
        <Term termId=“15.2.2”>
            <Name xml:lang=“en”>Running</Name>
        </Term>
        </Term>
```

14. The apparatus as recited in claim 1, wherein the UED CS includes a weather type CS for defining and describing weather environment conditions.

15. The apparatus as recited in claim 14, wherein the weather type CS defines and describe four season classification terms, general weather classification terms and extreme weather classification terms.

16. The apparatus as recited in claim 15, wherein the extreme weather classification terms describe Hurricane, Typhoon and Tornado.

17. The apparatus as recited in claim 15, wherein the four season classification terms are expressed as the following XML syntax:
```
    <Term termId=″1″>
        <Name xml:lang=″en″>Spring</Name>
        <Definition xml:lang=”en”>
            The season between winter and summer in which
leaves and flowers appear.
        </Definition>
              The season between autumn and spring when it is
  cold and most trees have lost their leaves.
          </Definition>
      </Term>
            The season between spring and autumn when the sun
is hot and there are many flower.
        </Definition>
    </Term>
    <Term termId=″3″>
        <Name xml:lang=″en″>Autumn</Name>
        <Definition xml:lang=”en”>
            The season between summer and winter when leaves
turn gold and fruits become ripe.
        </Definition>
    </Term>
    <Term termId=″4″>
        <Name xml:lang=″en″>Winter</Name>
        <Definition xml:lang=”en”>
            The season between autumn and spring when it is
cold and most trees have lost their leaves.
        </Definition>
    </Term>
```

18. The apparatus as recited in claim 15, wherein the general weather classification terms are expressed as the following XML syntax:
```
<Term termId=“5”>
        <Name xml:lang=“en”>Sunny</Name>
        <Definition xml:lang=“en”>
            Having bright sunlight.
        </Definition>
    </Term>
    <Term termId=“6”>
        <Name xml:lang=“en”>Rainy</Name>
        <Definition xml:lang=“en”>
            Having a lot of rain.
        </Definition>
    </Term>
    <Term termId=“7”>
        <Name xml:lang=“en”>Cloudy</Name>
        <Definition xml:lang=“en”>
            Full of clouds.
        </Definition>
    </Term>
    <Term termId=“8”>
        <Name xml:lang=“en”>Snowy</Name>
        <Definition xml:lang=“en”>
            Full of snow or snowing.
        </Definition>
    </Term>
    <Term termId=“9”>
        <Name xml:lang=“en”>Windy</Name>
        <Definition xml:lang=“en”>
            With a lot of wind.
        </Definition>
    </Term>
    <Term termId=“10”>
        <Name xml:lang=“en”>Foggy</Name>
        <Definition xml:lang=“en”>
            With a lot of fog.
        </Definition>
    </Term>
    <Term termId=“11”>
        <Name xml:lang=“en”>Frosty</Name>
        <Definition xml:lang=“en”>
            With a lot of frost.
        </Definition>
    </Term>
    <Term termId=“12”>
        <Name xml:lang=“en”>Storm</Name>
        <Definition xml:lang=“en”>
            A rough weather condition with wind, rain, and often
lightning.
        </Definition>
        <Term termId=“12.1”>
            <Name xml:lang=“en”>ThunderStorm</Name>
        </Term>
        <Term termId=“12.2”>
            <Name xml:lang=“en”>RainStorm</Name>
        </Term>
        <Term termId=“12.3”>
            <Name xml:lang=“en”>SnowStorm</Name>
        </Term>
```

19. The apparatus as recited in claim 15, wherein the extreme weather classification terms are expressed as the following XML syntax:
```
<Term termId=“13”>
        <Name xml:lang=“en”>Extreme Weather</Name>
        <Term termId=“13.1”>
            <Name xml:lang=“en”>Hurricane</Name>
        </Term>
        <Term termId=“13.2”>
            <Name xml:lang=“en”>Typhoon</Name>
        </Term>
        <Term termId=“13.3”>
            <Name xml:lang=“en”>Tornado</Name>
        </Term>
    </Term>
</ClassificationScheme>
```

20. An adaptive broadcasting service providing method using Usage Environment Description (UED) classification scheme (CS) to provide a targeting function for selecting an Audio video (AV) program, a package or components of the package based on a consumption environment and user preference, in an adaptive broadcasting system for providing broadcasting contents including AV programs and packages to a user terminal, comprising the steps of:
a) publishing metadata including the broadcasting contents and the UED CS to the user terminal;
b) providing contents identification information corresponding to a search and selection signal transmitted from the user terminal;
c) determining physical location of the broadcasting contents based on the contents identification information and providing location information; and
d) providing the broadcasting contents based on the location information,
wherein the UED CS is a kind of metadata describing a consumption environment of the contents.

21. The method as recited in claim 20, wherein the step b) includes the step of:
b1) providing metadata including the UED CS by using Electronic Program Guide (EPG).

22. The method as recited in claim 20, wherein the UED CS includes terminal type CS for describing types of user terminals.

23. The method as recited in claim 22, wherein the terminal type CS includes a car terminal type CS for describing types of car terminals.

24. The method as recited in claim 23, wherein the car terminal type CS describes a car stereo, a car navigation and a car AV.

25. The method as recited in claim 20, wherein the UED CS includes a location type CS for describing environment conditions of user location.

26. The method as recited in claim 25, wherein the location type CS includes a motion type information for describing motion environment conditions of a user in motion.

27. The method as recited in claim 25, wherein the motion type information includes:
public transportation type information indicating a motion type that a user uses a public transportation;
car type information indicating that a user uses a car;
train type information indicating that a user uses a train;
airplane type information indicating that a user uses an airplane; and
walking type information indicating that a user moves on foot.

28. The method as recited in claim 27, wherein the walking type information describes types of walking and types of running.

29. The method as recited in claim 20, wherein the UED CS includes a weather type CS for defining and describing a weather environment condition.

30. The method as recited in claim 29, wherein the weather type CS defines and describes four season classification terms, general weather classification terms and extreme weather classification terms.

31. The method as recited in claim 30, wherein the extreme weather classification terms describe Hurricane, Typhoon and Tornado.

32. The method as recited in claim 30, wherein the four season classification terms are expressed as the following XML syntax:
```
    <Term termId=″1″>
        <Name xml:lang=″en″>Spring</Name>
        <Definition xml:lang=”en”>
            The season between winter and summer in which
leaves and flowers appear.
        </Definition>
    </Term>
    <Term termId=″2″>
        <Name xml:lang=″en″>Summer</Name>
        <Definition xml:lang=”en”>
            The season between spring and autumn when the sun
is hot and there are many flower.
        </Definition>
    </Term>
    <Term termId=″3″>
        <Name xml:lang=″en″>Autumn</Name>
        <Definition xml:lang=”en”>
            The season between summer and winter when leaves
turn gold and fruits become ripe.
        </Definition>
    </Term>
    <Term termId=″4″>
        <Name xml:lang=″en″>Winter</Name>
        <Definition xml:lang=”en”>
```

33. The method as recited in claim 30, wherein the general weather classification terms are expressed as the following XML syntax:
```
<Term termId=“5”>
        <Name xml:lang=“en”>Sunny</Name>
        <Definition xml:lang=“en”>
            Having bright sunlight.
        </Definition>
    </Term>
    <Term termId=“6”>
        <Name xml:lang=“en”>Rainy</Name>
        <Definition xml:lang=“en”>
            Having a lot of rain.
        </Definition>
    </Term>
    <Term termId=“7”>
        <Name xml:lang=“en”>Cloudy</Name>
        <Definition xml:lang=“en”>
            Full of clouds.
        </Definition>
    </Term>
    <Term termId=“8”>
        <Name xml:lang=“en”>Snowy</Name>
        <Definition xml:lang=“en”>
            Full of snow or snowing.
        </Definition>
    </Term>
    <Term termId=“9”>
        <Name xml:lang=“en”>Windy</Name>
        <Definition xml:lang=“en”>
            With a lot of wind.
        </Definition>
    </Term>
    <Term termId=“10”>
        <Name xml:lang=“en”>Foggy</Name>
        <Definition xml:lang=“en”>
            With a lot of fog.
        </Definition>
    </Term>
    <Term termId=“11”>
        <Name xml:lang=“en”>Frosty</Name>
        <Definition xml:lang=“en”>
            With a lot of frost.
        </Definition>
    </Term>
    <Term termId=“12”>
        <Name xml:lang=“en”>Storm</Name>
        <Definition xml:lang=“en”>
            A rough weather condition with wind, rain, and often
lightning.
        </Definition>
        <Term termId=“12.1”>
            <Name xml:lang=“en”>ThunderStorm</Name>
        </Term>
        <Term termId=“12.2”>
            <Name xml:lang=“en”>RainStorm</Name>
        </Term>
        <Term termId=“12.3”>
            <Name xml:lang=“en”>SnowStorm</Name>
        </Term>
```

34. The method as recited in claim 30, wherein the extreme weather classification terms are expressed as the following XML syntax:
```
<Term termId=“13”>
        <Name xml:lang=“en”>Extreme Weather</Name>
        <Term termId=“13.1”>
            <Name xml:lang=“en”>Hurricane</Name>
        </Term>
        <Term termId=“13.2”>
            <Name xml:lang=“en”>Typhoon</Name>
        </Term>
        <Term termId=“13.3”>
            <Name xml:lang=“en”>Tornado</Name>
        </Term>
    </Term>
</ClassificationScheme>
```

35. An adaptive broadcasting system using UED CS, comprising:
an adaptive broadcasting service providing apparatus for providing broadcasting contents including an audio/video (AV) program and a package, and providing an adaptive broadcasting service supporting a synchronizing function and a targeting function; and
a user terminal for receiving and consuming the broadcasting contents and the metadata from the adaptive broadcasting service providing apparatus,
wherein the UED CS is a metadata describing a consumption environment of the contents in order that the user terminal can select contents which fit to user's environment and preference.

36. The system as recited in claim 35, wherein the adaptive broadcasting service providing apparatus includes:
a contents providing means for publishing and providing the metadata including the UED classification schemes to the user terminal; and
a contents searching means for providing contents identification information corresponding to a search and selection signal transmitted from the user terminal.

37. The system as recited in claim 36, wherein the user terminal includes:
a user interacting unit for searching, selecting and acquiring broadcasting contents by using the metadata including the UED CS, and driving components of the user terminal upon receipt of a user input signal;
a local storage managing unit for storing and managing the broadcasting contents and the metadata; and
a contents presenting unit for presenting the broadcasting contents and the metadata such that a user can watch the broadcasting contents and the metadata.

38. The system as recited in claim 36, wherein the user interacting unit receives the package, grasps attractive metadata of each component included in the package, and automatically or semiautomatically selects entire or part components to be consumed by comparing a user environment, in which the described components are properly consumed, and preference information with user's own environment and preference based on the UED CS.

39. The system as recited in claim 35, wherein the UED CS includes:
a terminal type CS for describing types of user terminals;
a location type CS for describing an environment condition of a user location; and
a weather type CS for defining and describing a weather environment condition.

40. A user terminal for receiving broadcasting contents including an audio/video (AV) program and a package by using Usage Environment Description (UED) classification scheme (CS) in an adaptive broadcasting system for providing an adaptive broadcasting service supporting a synchronizing function and a targeting function from an adaptive broadcasting service providing apparatus to the user terminal, the user terminal comprising:
a user interacting unit for searching, selecting and acquiring broadcasting contents based on metadata including the UED CS published from the adaptive broadcasting service providing apparatus;
a local storage managing unit for storing and managing the acquired broadcasting contents and metadata; and
a contents presenting unit for presenting the broadcasting contents and the metadata such that a user can use the broadcasting contents and the metadata,
wherein the UED CS is a metadata describing a consumption environment of the contents in order that the user terminal can select contents which fit to user's environment and preference.

41. The user terminal as recited in claim 40, wherein the user interacting unit grasps attractive metadata of each component included in the package, compares a proper user environment, in which each component is properly consumed, and preference information with user's own environment and preference by using UED CS, and automatically or semiautomatically selects entire or part of components to be consumed.

42. The user terminal as recited in claim 40, wherein the UED CS includes:
a terminal type CS for describing types of user terminals;
a location type CS for describing environment conditions of a user location; and
a weather type CS for defining and describing weather environment conditions.

43. The user terminal as recited in claim 42, wherein the terminal type CS includes a car terminal type CS for describing types of the car terminals.

44. The user terminal as recited in claim 42, wherein the location type CS includes motion type information for describing a motion environment condition of a user in motion.

45. A metadata structure, comprising:
UED CS for a TV-Anytime (TVA) broadcasting service,
wherein the UED CS includes,
a terminal type CS for classifiably describing a user terminal type;
a location type CS for classifiably describing an environment condition of a user location; and
a weather type CS for classifiably defining and describing an environment condition of weather.
